(19) United States
(12) Patent Application Publication
(10) Pub. No.: US 2007/0048616 A1
(43) Pub. Date: Mar. 1, 2007

(54) Gel electrolyte and secondary battery

(76) Inventors: Takefumi Okumura, Hitachi (JP); Shin Nishimura, Hitachi (JP); Norio Iwayasu, Hitachinaka (JP); Kazushige Kohno, Hitachi (JP); Shoichi Yokoyama, Handa (JP); Masato Mizutani, Kawasaki (JP); Tetsuya Itoh, Kamakura (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/376,092

(22) Filed: Mar. 16, 2006

(30) Foreign Application Priority Data
Mar. 18, 2005 (JP) 2005-079288

(51) Int. Cl. H01M 10/40

(52) U.S. Cl. 429/303; 429/317

(57) ABSTRACT

The present invention provides a high-power secondary battery using a gel electrolyte comprising a polymer matrix, which is obtained by polymerizing a polymerizable functional group-terminated borate represented by formula (1) or a mixture composed of a borate represented by formula (2) and a borate represented by formula (3), an electrolytic salt, and further a nonaqueous solvent: 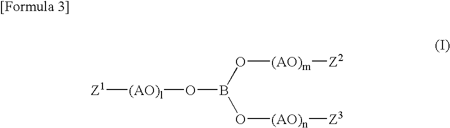
wherein Z¹, Z², and Z³ each independently represent a polymerizable functional group or a hydrocarbon group having 1 to 10 carbon atoms, provided that an average mole of the hydrocarbon group having 1 to 10 carbon atoms is 1.0 to 2.5 per the three groups of Z¹, Z² and Z³; AO represents an oxyalkylene group having 2 to 4 carbon atoms; 1, m, and n are each independently an average number of moles of the oxyalkylene group added of 0 to 100, provided that 1+m+n is 1 to 300; and B represents a boron atom; and 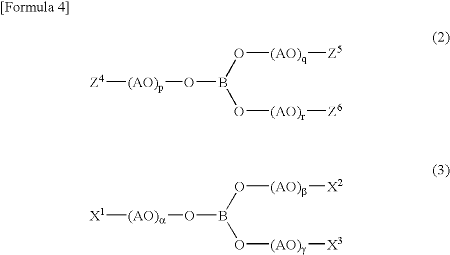
wherein Z⁴, Z⁵, and Z⁶ each independently represent a polymerizable functional group; AO represents an oxyalkylene group having 2 to 4 carbon atoms; p, q, r, α, β, and γ are each independently an average number of moles of the oxyalkylene group added of 0 to 100, provided that p+q+r is 1 to 300, and α+β+γ is 1 to 300; X¹, X², and X³ each independently represent a hydrocarbon group having 1 to 10 carbon atoms; and B represents a boron atom.

### BACKGROUND OF THE INVENTION

1. Field of the Invention

The present invention relates to a gel electrolyte suitable for a secondary battery and a secondary battery using the gel electrolyte.

2. Background Art

Up to the present, liquid electrolytes have been used as the electrolytes constituting electrochemical devices, such as secondary batteries, because of their high ionic conductivity. However, liquid electrolytes were problematic in terms of, for example, the possibility of damage to equipment due to fluid leakage caused by the internal pressure increase resulting from the vapor pressure of the liquid electrolytes ascribable to temperature rise and the gas generation ascribable to operation. In order to prevent this problem, liquid electrolytes were enclosed securely and tough outer cases were necessitated, and hence reduction in size, weight and thickness of electrochemical devices was hardly possible. Accordingly, as an attempt to overcome such drawbacks, secondary batteries using solid electrolytes, such as inorganic crystalline materials, inorganic glass, and organic polymers, have been proposed in recent years. Use of these solid electrolytes can result in less fluid leakage of carbonate solvents and less likelihood of electrolyte ignition than in case where conventional liquid electrolytes using carbonate solvents are used. This results in enhanced device reliability and safety. Among these solid electrolytes, in general, solid electrolytes consisting of organic polymers (hereinafter referred to as “polymer electrolytes”) have excellent processibility and moldability, electrolytes obtained therefrom have flexibility and bending workability, the degree of freedom in designing devices to which solid electrolytes are to be applied can be increased and so forth. Thus, development thereof has been expected. However, a polymer electrolyte obtained by making such an organic polymer as mentioned above, for example, polyethylene oxide, incorporate a specific alkali metal salt is lower in ionic conductivity than liquid electrolytes and at present inferior to liquid electrolytes (see, for example, Z. Stoeva et al., J. Am. Chem. Soc., 2003, 125, 4619).

In view of these circumstances, there is proposed a gel electrolyte that inhibits liquid leakage and also improves ionic conductivity by using a gel obtained by swelling an organic polymer as a matrix by use of a liquid electrolyte. Disclosed as a gel electrolyte are the gel electrolytes in which polyacrylonitrile polymer (see, for example, JP Patent Publication (Kokai) No. 7-45271 A (1995)), polyethylene oxide (see, for example, JP Patent Publication (Kokai) No. 6-68906 A (1994)), and polyalkyleneglycol(meth)acrylate (see, for example, JP Patent Publication (Kokai) No. 2002-63812 A) each are used as a polymer matrix. However, any one of these gel electrolytes has been found unsatisfactory in ionic conductivity and high-temperature stability, and moreover, in capability of coping with large current charge/discharge when used as battery electrolyte.

JP Patent Publication (Kokai) No. 2004-182982 A discloses an electrolyte using an ion conductive polymer obtained by polymerizing a borate represented by following formula (1) or an ion conductive copolymer obtained by polymerizing borates respectively represented by following formulas (2) and (3), and a secondary battery using the electrolyte; however, further improvement of ionic conductivity has been demanded.

### SUMMARY OF THE INVENTION

It is an object of the present invention to provide a gel electrolyte high in ionic conductivity and in high-temperature stability, and moreover, in capability of coping with large current when used as battery electrolyte, and a secondary battery.

More specifically, the present invention is as follows.

(1) A gel electrolyte comprising a polymer matrix, a nonaqueous solvent, and an electrolytic salt, wherein the polymer matrix is obtained by polymerizing a polymerizable functional group-terminated borate represented by formula (1): 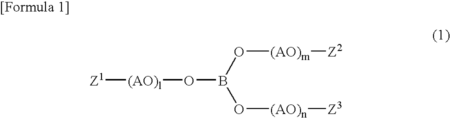
wherein Z¹, Z², and Z³ each independently represent a polymerizable functional group or a hydrocarbon group having 1 to 10 carbon atoms, provided that an average mole of the hydrocarbon group having 1 to 10 carbon atoms is 1.0 to 2.5 per the three groups of Z¹, Z² and Z³; AO represents an oxyalkylene group having 2 to 4 carbon atoms; 1, m, and n are each independently an average number of moles (or an average repetition number) of the oxyalkylene group added of 0 to 100, provided that l+m+n is 1 to 300; and B represents a boron atom.

(2) A gel electrolyte comprising a polymer matrix, a nonaqueous solvent, and an electrolytic salt, wherein the polymer matrix is obtained by polymerizing a mixture composed of a polymerizable functional group-terminated borate represented by formula (2) and a borate represented by formula (3): 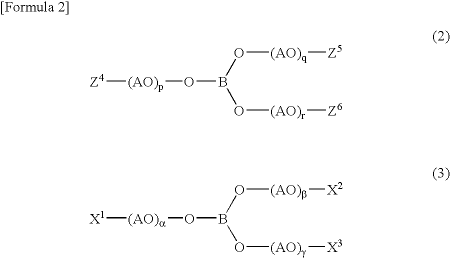
wherein Z⁴, Z⁵, and Z⁶ each independently represent a polymerizable functional group; AO represents an oxyalkylene group having 2 to 4 carbon atoms; p, q, r, α, β, and γ are each independently an average number of moles of the oxyalkylene group added, provided that p+q+r is 1 to 300, and α+β+γ is 1 to 300; X¹, X², and X³ each independently represent a hydrocarbon group having 1 to 10 carbon atoms; and B represents a boron atom.

(3) The gel electrolyte according to (2), wherein the molar ratio between the compound represented by formula (2) and the compound represented by formula (3) (the number of moles of the compound of formula (3)/the number of moles of the compound of formula (2)) is 1.0 to 3.0.

(4) The gel electrolyte according to (2), wherein the molar ratio between the compound represented by formula (2) and the compound represented by formula (3) (the number of moles of the compound of formula (3)/the number of moles of the compound of formula (2)) is 2.1 to 3.0.

(5) The gel electrolyte according to (1), (2), (3) or (4), wherein the amount, of the nonaqueous solvent is 50 to 95% by weight of the total amount of the electrolyte.

(6) The gel electrolyte according to (1), (2), (3) or (4), wherein the amount of the nonaqueous solvent is 60 to 93% by weight of the total amount of the electrolyte.

(7) A secondary battery comprising a positive electrode comprising a positive electrode active material that deintercalates and intercalates cations, a negative electrode comprising a negative electrode active material that intercalates and deintercalates cations deintercalated from the positive electrode, and an electrolyte layer that lies between the positive electrode and the negative electrode and allows the cations to migrate, wherein the electrolyte layer is formed of any one of the aforementioned gel electrolytes.

### BRIEF DESCRIPTION OF THE DRAWINGS

FIG. 1 is a schematic perspective view showing the structure of the test battery that is used in the Examples; and

FIG. 2 is a graph showing the relation between the ionic conductivity and the MTGB/PE90B ratio for each of the nonaqueous solvent contents presented in the Examples.

### DETAILED DESCRIPTION OF THE PREFERRED EMBODIMENTS

A polymerizable functional group-terminated borate represented by formula (1) can be obtained by boric acid esterification, with a boron compound, of a polymerizable functional group-containing monohydric alcohol or a monohydric alcohol containing a hydrocarbon group having 1 to 10 carbon atoms. Alternatively, the polymerizable functional group-terminated borate represented by formula (1) can also be obtained by transesterification of a mixture composed of a borate obtained by boric acid esterification, with a boron compound, of a polymerizable functional group-containing monohydric alcohol or a monohydric alcohol containing a hydrocarbon group having 1 to 10 carbon atoms.

The polymerizable functional group-terminated borate represented by formula (2) can be obtained by boric acid esterification, with a boron compound, of a polymerizable functional group-containing monohydric alcohol.

The borate represented by formula (3) can be obtained by boric acid esterification, with a boron compound, of a monohydric alcohol containing a hydrocarbon group having 1 to 10 carbon atoms.

Examples of the boron compound include: trialkyl borate compounds, such as trimethyl borate, triethyl borate, tripropyl borate, triisopropyl borate, tributyl borate, triisobutyl borate, and tri-t-butyl borate; and boric acid compounds, such as boric anhydride, orthoboric acid, metaboric acid, and pyroboric acid. Among these compounds, the trialkyl borate compounds are preferable because they can reduce the impurities contained in the borate to be obtained, and trimethyl borate and triethyl borate are more preferable because they allow the reaction temperature to be low and hence side reactions can be inhibited.

The polymerizable functional group-containing monohydric alcohol is, for example, a compound containing, in one and the same molecule, a polymerizable functional group, such as acryloyl, methacryloyl, vinyl or allyl, and a hydroxy group.

The monohydric alcohol containing a hydrocarbon group having 1 to 10 carbon atoms is, for example, a compound containing, in one and the same molecule, a hydrocarbon group, such as methyl, ethyl, propyl, isopropyl, butyl, isobutyl, t-butyl, hexyl, isohexyl, cyclohexyl, octyl, isooctyl, decyl, phenyl, toluyl, or naphthyl, and a hydroxy group.

In formula (1), Z¹, Z², and Z³ each represent a polymerizable functional group or a hydrocarbon group having 1 to 10 carbon atoms. In formula (2), Z⁴, Z⁵, and Z⁶ each represent a polymerizable functional group, and in formula (3), X¹, X², and X³ each represent a hydrocarbon group having 1 to 10 carbon atoms. Examples of such a polymerizable functional group include organic groups such as acryloyl, methacryloyl, vinyl, and allyl. Examples of the hydrocarbon group having 1 to 10 carbon atoms include saturated hydrocarbon groups such as methyl, ethyl, propyl, isopropyl, butyl, isobutyl, t-butyl, hexyl, isohexyl, cyclohexyl, octyl, isooctyl, and decyl; and aromatic hydrocarbon groups such as phenyl, toluyl, and naphthyl. Among these, methyl, ethyl, propyl, and isopropyl are preferable, and methyl is particularly preferable, because they can enhance the solubility associated with a nonaqueous solvent and an electrolytic salt.

In formulas (1), (2), and (3), AO represents an oxyalkylene group having 2 to 4 carbon atoms. Examples of the oxyalkylene group having 2 to 4 carbon atoms include organic groups such as oxyethylene, oxypropylene, oxybutylene, oxytetramethylene, polyoxyethylene, polyoxypropylene, polyoxybutylene, and polyoxytetramethylene. A organic group containing oxyethylene structure as a constituent unit is preferable because such an organic group can enhance the solubility associated with a nonaqueous solvent and an electrolytic salt. The oxyalkylene groups each having 2 to 4 carbon atoms may be of one kind or of two or more kinds, or the types of the oxyalkylene groups in one molecule may be different from each other; 1, m, and n in formula (1), p, q, and r in formula (2), and α, β, and γ in formula (3) each are the average number of moles of the oxyalkylene group added and are each independently 0 to 100, provided that 1+m+n, p+q+r, and α+β+γ each are 1 to 300. When 1, m, and n in formula (1), p, q, and r in formula (2), and α, β, and γ in formula (3) fall within the ranges specified above, the gel electrolyte to be obtained is excellent in shape retention.

In formula (1), an average mole of the hydrocarbon group having 1 to 10 carbon atoms per the three groups of Z¹, Z² and Z³ is 1.0 to 2.5, preferably 1.5 to 2.25, and more preferably 2.03 to 2.25; when the average mole concerned falls in the aforementioned ranges, the ionic conductivity and the capability of coping with large current charge/discharge are preferably excellent.

A mutual transesterification is carried between a polymerizable functional group-containing a borate represented by formula (2) and a borate represented by formula (3) through mixing of these two borates, and the proportions of Z⁴ to Z⁶ in a molecule and the proportions of X¹ to X³ in a molecule are thereby averaged.

The polymerizable functional group-containing borate represented by formula (2) is mixed with the borate represented by formula (3) in a mixing ratio preferably between 0.5 and 5.0, more preferably between 1.0 and 3.0, and furthermore preferably 2.1 and 3.0, in terms of the molar ratio (the number of moles of the borate of formula (3)/the number of moles of the borate of formula (2)). When the amount of the nonaqueous solvent is 60 to 93% by weight, the mixing ratio is preferably between 2.1 and 3.0 in terms of the above molar ratio. When the molar ratio falls in this range, the ionic conductivity and the capability of coping with large current charge/discharge are excellent. When the mixing ratio falls in the above ranges, the proportions of Z⁴ to Z⁶ in a molecule and the proportions of X¹ to X³ in a molecule are thereby averaged, and the number of the X¹ to X³, each being a hydrocarbon group having 1 to 10 carbon atoms, of the three terminal groups in a molecule becomes 1.0 to 2.5, more preferably 1.5 to 2.25, and furthermore preferably 2.03 to 2.25.

Any one of the borates represented by formula (1), (2), and (3) can be produced in accordance with a conventional technique or via the method described below. A boron compound, such as boric acid, boric anhydride, or alkyl borate, is added to a polymerizable functional group-containing monohydric alcohol and/or a monohydric alcohol containing a hydrocarbon group having 1 to 10 carbon atoms, and the reaction mixture thus obtained is subjected to pressure reduction at 30° C. to 200° C., with aeration using dry gas, to perform the boric acid esterification to yield the borate concerned. For example, the borate concerned can be produced via dehydration or devolatilization at a reaction temperature of 30° C. to 120° C. with aeration using an adequate amount of dry air or dry nitrogen for 2 to 12 hours while agitating under reduced pressure of 0.67 to 66.7 kPa (5 to 500 mmHg). When a polymerizable functional group-containing borate represented by formula (1) or (2) is to be produced, the reaction temperature is preferably set between 30° C. and 80° C., and the dry gas to be used for aeration is preferably dry air, from the viewpoint of protecting the polymerizable functional group(s).

The borate concerned is preferably produced using trialkyl borate, and particularly trimethyl borate, from the viewpoint of reduction in the water content in the borate to be obtained or the like. When trialkyl borate is used, it is particularly preferable to produce the borate concerned by using 1.0 to 10 moles of trialkyl borate based on 3.0 moles of the total amount of the active hydrogen-containing compounds and removing, by distillation, volatile components and an excess amount of trialkyl borate resulting from transesterification.

When the borate represented by formula (1) is polymerized, the polymer to be obtained may be a polymer derived from a single compound represented by formula (1), or a copolymer derived from another compound represented by formula (1) and a polymerizable compound other than this compound. The polymer obtained may be used as a mixture with another polymer compounds. Also, when a mixture composed of a borate represented by formula (2) and a borate represented by formula (3) is subjected to polymerization, the polymer to be obtained may be a polymer derived solely from the aforementioned mixture, or a copolymer derived from the aforementioned mixture and another polymerizable compound.

The gel electrolyte of the present invention may comprise, to be used in combination, other polymer compounds and other polymerizable compounds, in order to improve the strength and flexibility of the electrolyte. Examples of such other polymerizable compounds include: (meth)acrylate compounds, such as methyl acrylate, ethyl acrylate, propyl acrylate, butyl acrylate, hexyl acrylate, octyl acrylate, 2-ethylhexyl acrylate, cyclohexyl acrylate, dodecyl acrylate, octadecyl acrylate, glycerol-1,3-diacrylate, trimethylolpropane triacrylate, pentaerythritol tetraacrylate, diglycerol tetraacrylate, dipentaerythritol hexaacrylate, methyl methacrylate, ethyl methacrylate, propyl methacrylate, butyl methacrylate, hexyl methacrylate, octyl methacrylate, 2-ethylhexyl methacrylate, cyclohexyl methacrylate, dodecyl methacrylate, octadecyl methacrylate, glycerol-1,3-dimethacrylate, trimethylolpropane trimethacrylate, pentaerythritol tetramethacrylate, diglycerol tetramethacrylate and dipentaerythritol hexamethacrylate; polyalkylene glycol(meth)acrylate compounds, such as methoxypolyalkylene glycol acrylate, dodecyloxypolyalkylene glycol acrylate, octadecyloxypolyalkylene glycol acrylate, polyalkylene glycol diacrylate, glycerol tris(polyalkyleneglycol)ether triacrylate, trimethylolpropane tris(polyalkylene glycol)ether triacrylate, pentaerythritol tetrakis(polyalkylene glycol)ether tetraacrylate, diglycerol tetrakis(polyalkylene glycol)tetraacrylate, methoxypolyalkylene glycol methacrylate, dodecyloxypolyalkylene glycol methacrylate, octadecyloxypolyalkylene glycol methacrylate, polyalkylene glycol dimethacrylate, glycerol tris(polyalkylene glycol)ether trimethacrylate, trimethylolpropane tris(polyalkylene glycol)ether trimethacrylate, pentaerythritol tetrakis(polyalkylene glycol)ether tetramethacrylate and diglycerol tetrakis(polyalkylene glycol)tetramethacrylate; and glycidyl ether compounds, such as trimethylolpropane polyglycidyl ether, neopentyl glycol diglycidyl ether, bisphenol A glycidyl ether, glycidyl ether of a bisphenol A ethylene oxide adduct, and polyalkylene glycol diglycidyl ether.

Such other polymerizable compounds may be used alone or in combinations of two or more. Alternatively, one or more kinds of such compounds may be previously subjected to bulk polymerization, solution polymerization, emulsion polymerization, or other means to obtain a polymer, and a resulting polymer may be used. From the viewpoint of handleability, a (meth)acrylate or polyalkylene glycol(meth)acrylate compound is preferable. From the viewpoint of ionic conductivity, a polyalkylene glycol (meth)acrylate compound is further preferable.

Examples of such other polymer compounds include polyvinylidene fluoride (PVdF), a copolymer of hexafluoropropylene and acrylonitrile (PHFP-AN), styrene-butadiene rubber (SBR), carboxymethylcellulose (CMC), methylcellulose (MC), ethylcellulose (EC), polyvinyl alcohol (PVA), polyethylene oxide (PEO), a copolymer of polyethylene oxide and polypropylene oxide (PEO—PPO), and polymer compounds such as one or more polymers of the aforementioned other polymerizable compounds. Among these, polyethylene oxide, a copolymer of polyethylene oxide and polypropylene oxide, and a polymer containing a polyalkylene glycol (meth)acrylate compound are preferable from the viewpoint of ionic conductivity.

Such other polymerizable or polymer compounds may be used alone or in combinations of two or more. When other polymerizable compounds are used, such polymerizable compounds may be previously subjected to homopolymerization via, for example, bulk polymerization, solution polymerization, or emulsion polymerization, or copolymerization with other polymerizable compounds.

The nonaqueous solvent to be used in the gel electrolyte of the present invention is a solvent compatible with an electrolytic salt, the aforementioned borates, other polymerizable compounds and other polymer compounds when they are mixed with the solvent. Examples of such a nonaqueous solvent include: carbonate compounds, such as ethylene carbonate, propylene carbonate, butylene carbonate, dimethyl carbonate, diethyl carbonate, and methyl ethyl carbonate; and ether compounds, such as y-butyrolactone, tetrahydrofuran, ethylene glycol dimethyl ether, diethylene glycol dimethyl ether, triethylene glycol dimethyl ether, ethylene glycol methyl ethyl ether, ethylene glycol diethyl ether, diethylene glycol methyl ethyl ether, diethylene glycol diethyl ether, propylene glycol dimethyl ether, and dipropylene glycol dimethyl ether. The aforementioned nonaqueous solvents may be used alone or in combinations of two or more. Moreover, conventional additives for lithium secondary batteries such as vinylene carbonate may also be used.

When the amount of the nonaqueous solvent is 50 to 95% by weight in the gel electrolyte of the present invention, the ionic conductivity is 1 mS/cm or more preferably from the viewpoint of battery output power. When the amount of the nonaqueous solvent is 60 to 93% by weight, particularly preferably the liquid holding capability of the solvent can be ensured and the battery output power is also further improved.

As the electrolytic salt to be used in the gel electrolyte of the present invention, any electrolytic salt that is soluble in the gel electrolyte can be used without particular limitation, and the following compounds are preferable. Specific examples thereof include compounds comprising a metal cation and an anion selected from the group consisting of chlorine, bromine, iodine, perchlorate, thiocyanate, tetrafluoroborate, hexafluorophosphate, trifluoromethane-sulfonimide ion, bispentafluoroethane-sulfonimide ion, stearyl sulfonate, octyl sulfonate, dodecylbenzenesulfonate, naphthalenesulfonate, dodecylnaphthalenesulfonate, 7,7,8,8-tetracyano-p-quinodimethane, and lower aliphatic carboxylate ions. An example of a metal cation is Li. The concentration of the electrolytic salt is to be determined in consideration of the ionic conductivity required for the gel electrolyte and other conditions, and is usually between 0.1 and 4.0 mole/kg, and preferably between 0.5 and 3.0 mole/kg.

When the gel electrolyte of the present invention is prepared, a polymerization initiator may or may not be used. Thermal polymerization utilizing a radical polymerization initiator is preferable from the viewpoint of workability and the speed of polymerization.

Examples of a radical polymerization initiator include: organic peroxides, such as t-butylperoxy pivalate, t-hexylperoxy pivalate, methyl ethyl ketone peroxide, cyclohexanone peroxide, 1,1-bis(t-butylperoxy)-3,3,5-trimethylcyclohexane, 2,2-bis(t-butylperoxy)octane, n-butyl-4,4-bis(t-butylperoxy)valerate, t-butyl hydroperoxide, cumene hydroperoxide, 2,5-dimethylhexane-2,5-dihydroperoxide, di-t-butyl peroxide, t-butylcumyl peroxide, dicumyl peroxide, α,α′-bis(t-butylperoxy-m-isopropyl)benzene, 2,5-dimethyl-2,5-di(t-butylperoxy)hexane, benzoyl peroxide and t-butylperoxypropyl carbonate; and azo compounds, such as 2,2′-azobisisobutylonitrile, 2,2′-azobis(2-methylbutylonitrile), 2,2′-azobis(4-methoxy-2,4-dimethylvaleronitrile), 2,2′-azobis(2,4-dimethylvaleronitrile), 1,1′-azobis(cyclohexane-1-carbonitrile), 2-(carbamoylazo)isobutylonitrile, 2-phenylazo-4-methoxy-2,4-dimethyl-valeronitrile, 2,2′-azobis(2-methyl-N-phenylpropionamidine)dihydrochloride, 2,2′-azobis[N-(4-chlorophenyl)-2-methylpropionamidine]dihydrochloride, 2,2′-azobis[N-hydroxyphenyl]-2-methylpropionamidine]dihydrochloride, 2,2′-azobis[2-methyl-N-(phenylmethyl)propionamidine]dihydrochloride, 2,2′-azobis[2-methyl-N-(2-propenyl)propionamidine]dihydrochloride, 2,2′-azobis(2-methylpropionamidine)dihydrochloride, 2,2′-azobis[N-(2-hydroxyethyl)-2-methylpropionamidine]dihydrochloride, 2,2′-azobis[2-(5-methyl-2-imidazolin-2-yl)propane]dihydrochloride, 2,2′-azobis[2-(2-imidazolin-2-yl)propane]dihydrochloride, 2,2′-azobis[2-(4,5,6,7-tetrahydro-1H-1,3-diazepin-2-yl)propane]dihydrochloride, 2,2′-azobis[2-(3,4,5,6-tetrahydropyrimidin-2-yl)propane]dihydrochloride, 2,2′-azobis[2-(5-hydroxy-3,4,5,6-tetrahydropyrimidin-2-yl)propane]dihydrochloride, 2,2′-azobis{2-[1-(2-hydroxyethyl)-2-imidazolin-2-yl]propane}dihydrochloride, 2,2′-azobis[2-(2-imidazolin-2-yl)propane], 2,2′-azobis{2-methyl-N-[1,1-bis(hydroxymethyl)-2-hydroxyethyl]propionamide}, 2,2′-azobis{2-methyl-N-[1,1-bis(hydroxymethyl)ethyl]propionamide}, 2,2′-azobis[2-methyl-N-(2-hydroxyethyl)propionamide], 2,2′-azobis(2-methylpropionamide)dihydrate, 2,2′-azobis(2,4,4-trimethylpentane), 2,2′-azobis(2-methylpropane), dimethyl-2,2′-azobisisobutyrate, 4,4′-azobis(4-cyanovaleric acid) and 2,2′-azobis[2-(hydroxymethyl)propionitrile].

Production of a polymer utilizing a radical polymerization initiator can be carried out within a general temperature range and polymerization time. In order to avoid damaging the members used for an electrochemical device, use of a radical polymerization initiator with a 10 hour half-life decomposition temperature range of 30 to 90° C., which is the indicator of the decomposition temperature and the rate, is preferable. The term “10 hour half-life decomposition temperature” refers to the temperature required to bring the amount of undecomposed radical polymerization initiator to a half of the initial amount within 10 hours when the concentration of the initiator in a radical inactive solvent such as benzene is 0.01 mole/liter. The polymerization temperature is set to be between the 10 hour half-life decomposition temperature of −10° C. and the 10 hour half-life decomposition temperature of +50° C. of the initiator utilized. The polymerization time is between 0.1 and 100 hours. In the present invention, the amount of the initiator to be incorporated is 0.01 mole percent or more and 10 mole percent or less, and preferably 0.1 mole percent or more and 5 mole percent or less, based on 1 mole of the total amount of the polymerizable functional groups contained in the aforementioned borates and the polymerizable functional groups contained other polymerizable compounds.

A positive electrode that reversibly intercalates and deintercalates lithium in the present invention is obtained by applying the following slurry to a charge collector made of a metal foil such as aluminum foil to form a coating film and by pressing the coating film so as to have a predetermined density. The slurry is prepared by mixing the following mixture with a polymer compound solution in a low boiling point solvent, or one or more polymerizable compounds. The mixture may comprise as the positive electrode active materials: layered compounds such as lithium cobalt oxide (LiCoO₂), lithium nickel oxide (LiNiO₂), layered lithium manganese oxide (LiMnO₂), and LiMnₓNi_{y}Co_{z}O₂ (x+y+z=1, 0≦y<1, 0≦z<1, 0≦x<1) which is a composite oxide comprising a plurality of transition metal elements; a layered compound in which at least one kind of transition metal has been substituted; lithium manganese oxides (Li₁₊ₓMn₂₋ₓO₄, where x=0 to 0.33; Li₁₊ₓMn_{2-x-y}M_{y}O₄, where M is at least one member selected from the group of metals consisting of Ni, Co, Cr, Cu, Fe, Al, and Mg, x=0 to 0.33, and y=0 to 1.0, and 2−x−y>0; LiMnO₃, LiMn₂O₃, LiMnO₂, LiMn₂₋ₓMₓO₂, where M is at least one member selected from the group of metals consisting of Co, Ni, Fe, Cr, Zn, and Ta, and x=0.01 to 0.1; and Li₂Mn₃MO₈, where M is at least one member selected from the group of metals consisting of Fe, Co, Ni, Cu, and Zn); a copper-lithium oxide (Li₂CuO₂); an oxide of vanadium such as LiV₃O₈, LiFe₃O₄, V₂O₅, or Cu₂V₂O₇; a disulphide compound; or Fe₂(MoO₄)₃.

Materials used as the negative electrode active material for the negative electrode that reversibly intercalates and deintercalates lithium in the present invention may comprise: an easily graphitizable material obtained from natural graphite, petroleum coke, coal pitch coke, or the like that has been subjected to heat treatment at high temperatures of 2500° C. or higher; mesophase carbon or amorphous carbon; carbon fiber; a metal that alloys with lithium; and a carbon particle carrying a metal on the surface thereof. A slurry is prepared by mixing the aforementioned negative electrode active materials with a polymer compound solution in a low boiling point solvent, or one or more polymerizable compounds; the negative electrode is obtained by applying the slurry to a charge collector made of a metal foil such as copper foil to form a coating film and by pressing the coating film so as to have a predetermined density. Metals selected from the group consisting of lithium, aluminum, tin, silicon, indium, gallium, and magnesium, and the alloys and oxides of these metals may also be utilized for the negative electrode active material.

The secondary battery according to the present invention can be obtained by, for example, inserting a gel electrolyte between the positive electrode and the negative electrode obtained by coating on the metal foil. The secondary battery concerned can also be obtained as follows: a composition composed of a borate, a nonaqueous solvent and an electrolytic salt is applied to the positive or negative electrode and cured to form an electrolyte layer on the positive or negative electrode; and then these electrodes are stuck together to form the battery. Alternatively, the secondary battery concerned can also be obtained as follows: a separator film made of a porous polyolefin or the like is sandwiched between the positive and negative electrodes, penetrated by the aforementioned composition, and then cured to form the battery.

The application of the lithium secondary battery of the present invention is not particularly limited, and the secondary battery concerned can be used as the electric power supplies for, for example, IC cards, personal computers, main frame computers, laptop computers, pen-operated personal computers, laptop word processors, cellular phones, handy cards, wrist watches, cameras, electric shavers, cordless phones, facsimiles, video devices, video cameras, electronic organizers, electronic calculators, electronic organizers with communication function, portable copiers, liquid crystal television sets, electric tools, vacuum cleaners, game consoles with virtual reality and other functions, toys, electric bicycles, healthcare walking aids, healthcare wheelchairs, mobile healthcare beds, escalators, elevators, forklifts, golf carts, emergency power supplies, road conditioners, and electric power storage systems. The secondary battery concerned can be used for civil as well as military or space applications.

### EXAMPLES

The present invention is hereafter described in greater detail with reference to the examples, although the technical scope of the present invention is not limited thereto. In present Examples, preparation and evaluation of samples were carried out under an argon atmosphere unless otherwise specified. Examples and Comparative Examples of the present invention are summarized in Table 1.

1. Preparation Example of Electrodes

<Positive Co electrode>: Lithium cobalt oxide (trade name: Cellseed, Nippon Chemical Industrial Co., Ltd.), graphite (trade name: SP270, Nippon Graphite Industries, Ltd.), and polyvinylidene fluoride (trade name: KF1120, Kureha Chemical Industry Co., Ltd.) were mixed together in a mixing ratio of 80:10:10 in terms of percent by weight. The mixture thus obtained was placed in N-methyl-2-pyrrolidinone, and mixed to prepare a slurry solution. The slurry was applied to aluminum foil with a thickness of 20 μm by the doctor blade method and dried to form an electrode mixture layer. The amount of the mixture applied was 150 g/m². The aluminum foil was pressed to bring the bulk density of the mixture to be 3.0 g/cm³ and then cut into 1 cm×1 cm sections to prepare positive electrodes.

<Positive Mn electrode>: Lithium manganese oxide powder (trade name: E10Z, Nikki Chemical Co., Ltd.), amorphous carbon (trade name: Carbotron PE, Kureha Chemical Industry Co., Ltd.), and polyvinylidene fluoride (trade name: KF1120, Kureha Chemical Industry Co., Ltd.) were mixed together in a mixing ratio of 80:10:10 in terms of percent by weight. The mixture thus obtained was placed in N-methyl-2-pyrrolidinone, and mixed to prepare a slurry solution. The slurry was applied to aluminum foil with a thickness of 20 μm by the doctor blade method and dried. The amount of the mixture applied was 225 g/m². The aluminum foil was pressed to bring the bulk density of the mixture to be 2.5 g/cm³ and then cut into 1 cm×1 cm sections to prepare positive electrodes.

<Negative electrode>: Amorphous carbon (trade name: Carbotron PE, Kureha Chemical Industry, Co., Ltd.) and polyvinylidene fluoride (trade name: KF1120, Kureha Chemical Industry, Co., Ltd.) were mixed together in a mixing ratio of 90:10 in terms of percent by weight. The mixture thus obtained was placed in N-methyl-2-pyrrolidinone, and mixed to prepare a slurry solution. The slurry was applied to copper foil with a thickness of 20 μm by the doctor blade method and dried. The amount of the mixture applied was 70 g/m². The copper foil was pressed to bring the bulk density of the mixture to be 1.0 g/cm³ and then cut into 1.2 cm×1.2 cm sections to prepare negative electrodes.

2. Evaluation Methods

<Ionic conductivity>: Ionic conductivity measurement was performed by the alternating current impedance method as follows: a gel electrolyte was sandwiched between a pair of stainless steel electrodes at 25° C. to form an electrochemical cell, an alternating current was applied between the electrodes to measure the resistance component, and the ionic conductivity was derived from the real impedance intercept in the Cole-Cole plot.

<Battery charge/discharge>: A charge/discharge operation was performed using a charger/discharger (TOSCAT3000, Toyo System Co., Ltd.) at room temperature with a current density of 0.36 mA/cm². Constant current charge operation was performed up to 4.2 V, whereupon constant voltage charge operation was performed for 12 hours. Further, constant current discharge operation was performed until the voltage reached a discharge termination voltage of 3.5 V. The capacity that was achieved by the initial discharge was determined to be the initial discharge capacity. A cycle of charging and discharging under the above conditions was repeated until the capacity decreased to 70% or less of the initial discharge capacity, and the number of times the cycle was repeated was designated as a cycle characteristic. Also, constant current charge operation was performed with a current density of 3.6 mA/cm² up to 4.2 V, whereupon constant voltage charge operation was performed for 12 hours. Further, constant current discharge operation was performed until the voltage reached a discharge termination voltage of 3.5 V. The resulting capacity was compared with the initial cycle capacity obtained in the aforementioned charge/discharge cycle, and the ratio was designated as a high-speed charge/discharge characteristic.

<Direct current resistance (DCR)>: A charge/discharge operation was performed using the charger/discharger (TOSCAT3000, Toyo System Co., Ltd.) at room temperature with a current density of 0.6 mA/cm². Constant current charge operation was performed up to 4.2 V, whereupon constant voltage charge operation was performed for 12 hours. Further, constant current discharge operation was performed with a current density of 1.8 mA/cm² until the voltage reached a discharge termination voltage of 3.5 V. The voltage variation in a period of 5 seconds after the discharge termination was designated as V1. Thereafter, a charge operation was performed under the same conditions as mentioned above, and further, constant current discharge operation was performed with a current density of 3.6 mA/cm² until the voltage reached the discharge termination voltage of 3.5 V. The voltage variation in a period of 5 seconds after the discharge termination was designated as V2. Further, a charge operation was performed under the same conditions as mentioned above, and constant current discharge operation was performed with a current density of 5.4 mA/cm² until the voltage reached the discharge termination voltage of 3.5 V. The voltage variation in a period of 5 seconds after the discharge termination was designated as V3. The discharge current densities were plotted along the X axis and the corresponding voltage variations (V1, V2, V3) were plotted along the Y axis, and the slope of the plot was taken as the DCR.

### Example 1

A 1:1 (molar ratio) mixture (28.2 g) composed of the borate of diethylene glycol monomethacrylate (PE90B; Z⁴, Z⁵, Z⁶: methacryloly groups; AO: an oxyethylene group; p, q, r: 2) and the borate of triethylene glycol monomethyl ether (MTGB; X¹, X², X³: methyl groups; AO: an oxyethylene group; α, β, γ: 3), 65.8 g of a 1:1 (volume ratio) mixed solvent composed of ethylene carbonate and diethyl carbonate, and 6.0 g of LiBF₄ added further were mixed to yield a solution. Further, 0.484 g of Perhexyl PV (manufactured by NOF Corporation) as a polymerization initiator was added to the solution to yield a gel electrolyte precursor solution A. The solution was poured into a 0.5 mm wide space between a pair of stainless steel electrodes and retained at 65° C. for 2 hours in a sealed vessel to yield a gel electrolyte. The ionic conductivity of the gel electrolyte was measured by the aforementioned ionic conductivity measurement method.

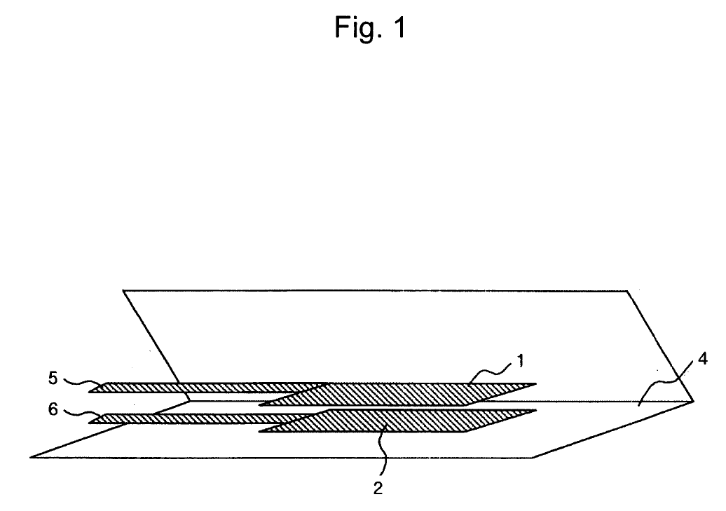

Next, the positive Mn electrode and the negative electrode prepared by the aforementioned methods were made to face each other with a separator mediating therebetween; as shown in FIG. 1, stainless steel terminals 5 and 6 were attached to the positive electrode 1 and the negative electrode 2, respectively, and the electrodes were inserted into a pouched aluminum laminate film 7. Further, the gel electrolyte precursor solution A was injected into the separator, and then the pouched aluminum laminate film 7 was sealed and retained at 65° C. for 2 hours to prepare a battery. The characteristics and the ionic conductivity of the prepared battery are shown in Table 1.

Additionally, inspection of the prepared battery by peeling off the aluminum laminate film thereof proved that no fluidity of the electrolyte solution was found inside the battery.

### Example 2

A 1:1.5 (molar ratio) mixture (28.2 g) composed of the borate of diethylene glycol monomethacrylate (PE90B) and the borate of triethylene glycol monomethyl ether (MTGB), 65.8 g of a 1:1 (volume ratio) mixed solvent composed of ethylene carbonate and diethyl carbonate, and 6.0 g of LiBF₄ added further were mixed to yield a solution. Further, 0.484 g of Perhexyl PV (manufactured by NOF Corporation) as a polymerization initiator was added to the solution to yield a gel electrolyte precursor solution B. The solution was poured into a 0.5 mm wide space between a pair of stainless steel electrodes and retained at 65° C. for 2 hours in a sealed vessel to yield a gel electrolyte. The ionic conductivity of the gel electrolyte was measured by the aforementioned ionic conductivity measurement method.

Next, the positive Mn electrode and the negative electrode prepared by the aforementioned methods were made to face each other with a separator mediating therebetween; as shown in FIG. 1, stainless steel terminals 5 and 6 were attached to the positive electrode 1 and the negative electrode 2, respectively, and the electrodes were inserted into a pouched aluminum laminate film 4. Further, the gel electrolyte precursor solution B was injected into the separator, and then the pouched aluminum laminate film 4 was sealed and retained at 65° C. for 2 hours to prepare a battery. The characteristics and the ionic conductivity of the prepared battery are shown in Table 1.

Additionally, inspection of the prepared battery by peeling off the aluminum laminate film thereof proved that no fluidity of the electrolyte solution was found inside the battery.

### Example 3

A 1:2.0 (molar ratio) mixture (28.2 g) composed of the borate of diethylene glycol monomethacrylate (PE90B) and the borate of triethylene glycol monomethyl ether (MTGB), 65.8 g of a 1:1 (volume ratio) mixed solvent composed of ethylene carbonate and diethyl carbonate, and 6.0 g of LiBF₄ added further were mixed to yield a solution. Further, 0.484 g of Perhexyl PV (manufactured by NOF Corporation) as a polymerization initiator was added to the solution to yield a gel electrolyte precursor solution C. The solution was poured into a 0.5 mm wide space between a pair of stainless steel electrodes and retained at 65° C. for 2 hours in a sealed vessel to yield a gel electrolyte. The ionic conductivity of the gel electrolyte was measured by the aforementioned ionic conductivity measurement method.

Next, the positive Mn electrode and the negative electrode prepared by the aforementioned methods were made to face each other with a separator mediating therebetween; as shown in FIG. 1, stainless steel terminals 5 and 6 were attached to the positive electrode 1 and the negative electrode 2, respectively, and the electrodes were inserted into a pouched aluminum laminate film 4. Further, the gel electrolyte precursor solution C was injected into the separator, and then the pouched aluminum laminate film 4 was sealed and retained at 65° C. for 2 hours to prepare a battery. The characteristics and the ionic conductivity of the prepared battery are shown in Table 1.

Additionally, inspection of the prepared battery by peeling off the aluminum laminate film thereof proved that no fluidity of the electrolyte solution was found inside the battery.

### Example 4

A 1:2.5 (molar ratio) mixture (28.2 g) composed of the borate of diethylene glycol monomethacrylate (PE90B) and the borate of triethylene glycol monomethyl ether (MTGB), 65.8 g of a 1:1 (volume ratio) mixed solvent composed of ethylene carbonate and diethyl carbonate, and 6.0 g of LiBF₄ added further were mixed to yield a solution. Further, 0.484 g of Perhexyl PV (manufactured by NOF Corporation) as a polymerization initiator was added to the solution to yield a gel electrolyte precursor solution D. The solution was poured into a 0.5 mm wide space between a pair of stainless steel electrodes and retained at 65° C. for 2 hours in a sealed vessel to yield a gel electrolyte. The ionic conductivity of the gel electrolyte was measured by the aforementioned ionic conductivity measurement method.

Next, the positive Mn electrode and the negative electrode prepared by the aforementioned methods were made to face each other with a separator mediating therebetween; as shown in FIG. 1, stainless steel terminals 5 and 6 were attached to the positive electrode 1 and the negative electrode 2, respectively, and the electrodes were inserted into a pouched aluminum laminate film 4. Further, the gel electrolyte precursor solution D was injected into the separator, and then the pouched aluminum laminate film 4 was sealed and retained at 65° C. for 2 hours to prepare a battery. The characteristics and the ionic conductivity of the prepared battery are shown in Table 1.

Additionally, inspection of the prepared battery by peeling off the aluminum laminate film thereof proved that no fluidity of the electrolyte solution was found inside the battery.

### Example 5

A 1:2.5 (molar ratio) mixture (9.4 g) composed of the borate of diethylene glycol monomethacrylate (PE90B) and the borate of triethylene glycol monomethyl ether (MTGB), 84.6 g of a 1:1 (volume ratio) mixed solvent composed of ethylene carbonate and diethyl carbonate, and 6.0 g of LiBF₄ added further were mixed to yield a solution. Further, 0.484 g of Perhexyl PV (manufactured by NOF Corporation) as a polymerization initiator was added to the solution to yield a gel electrolyte precursor solution E. The solution was poured into a 0.5 mm wide space between a pair of stainless steel electrodes and retained at 65° C. for 2 hours in a sealed vessel to yield a gel electrolyte. The ionic conductivity of the gel electrolyte was measured by the aforementioned ionic conductivity measurement method.

Next, the positive Mn electrode and the negative electrode prepared by the aforementioned methods were made to face each other with a separator mediating therebetween; as shown in FIG. 1, stainless steel terminals 5 and 6 were attached to the positive electrode 1 and the negative electrode 2, respectively, and the electrodes were inserted into a pouched aluminum laminate film 4. Further, the gel electrolyte precursor solution E was injected into the separator, and then the pouched aluminum laminate film 4 was sealed and retained at 65° C. for 2 hours to prepare a battery. The characteristics and the ionic conductivity of the prepared battery are shown in Table 1.

Additionally, inspection of the prepared battery by peeling off the aluminum laminate film thereof proved that no fluidity of the electrolyte solution was found inside the battery.

### Example 6

A 1:3.0 (molar ratio) mixture (9.4 g) composed of the borate of diethylene glycol monomethacrylate (PE90B) and the borate of triethylene glycol monomethyl ether (MTGB), 84.6 g of a 1:1 (volume ratio) mixed solvent composed of ethylene carbonate and diethyl carbonate, and 6.0 g of LiBF₄ added further were mixed to yield a solution. Further, 0.484 g of Perhexyl PV (manufactured by NOF Corporation) as a polymerization initiator was added to the solution to yield a gel electrolyte precursor solution F. The solution was poured into a 0.5 mm wide space between a pair of stainless steel electrodes and retained at 65° C. for 2 hours in a sealed vessel to yield a gel electrolyte. The ionic conductivity of the gel electrolyte was measured by the aforementioned ionic conductivity measurement method.

Next, the positive Mn electrode and the negative electrode prepared by the aforementioned methods were made to face each other with a separator mediating therebetween; as shown in FIG. 1, stainless steel terminals 5 and 6 were attached to the positive electrode 1 and the negative electrode 2, respectively, and the electrodes were inserted into a pouched aluminum laminate film 4. Further, the gel electrolyte precursor solution F was injected into the separator, and then the pouched aluminum laminate film 4 was sealed and retained at 65° C. for 2 hours to prepare a battery. The characteristics and the ionic conductivity of the prepared battery are shown in Table 1.

Additionally, inspection of the prepared battery by peeling off the aluminum laminate film thereof proved that no fluidity of the electrolyte solution was found inside the battery.

### Example 7

A 1:2.5 (molar ratio) mixture (7.7 g) composed of the borate of diethylene glycol monomethacrylate (PE90B) and the borate of triethylene glycol monomethyl ether (MTGB), 69.2 g of a 1:1 (volume ratio) mixed solvent composed of ethylene carbonate and diethyl carbonate, and 23.1 g of LiN(C₂F₅SO₂)₂ added further were mixed to yield a solution. Further, 0.484 g of Perhexyl PV (manufactured by NOF Corporation) as a polymerization initiator was added to the solution to yield a gel electrolyte precursor solution G. The solution was poured into a 0.5 mm wide space between a pair of stainless steel electrodes and retained at 65° C. for 2 hours in a sealed vessel to yield a gel electrolyte. The ionic conductivity of the gel electrolyte was measured by the aforementioned ionic conductivity measurement method.

Next, the positive Mn electrode and the negative electrode prepared by the aforementioned methods were made to face each other with a separator mediating therebetween; as shown in FIG. 1, stainless steel terminals 5 and 6 were attached to the positive electrode 1 and the negative electrode 2, respectively, and the electrodes were inserted into a pouched aluminum laminate film 7. Further, the gel electrolyte precursor solution G was injected into the separator, and then the pouched aluminum laminate film 7 was sealed and retained at 65° C. for 2 hours to prepare a battery. The characteristics and the ionic conductivity of the prepared battery are shown in Table 1.

Additionally, inspection of the prepared battery by peeling off the aluminum laminate film thereof proved that no fluidity of the electrolyte solution was found inside the battery.

### Example 8

A battery was prepared and evaluation thereof was carried out in a manner identical to that in Example 1 except that the aforementioned positive Co electrode was used in place of the positive Mn electrode used in Example 1. The characteristics and the ionic conductivity of the prepared battery are shown in Table 1.

Additionally, inspection of the prepared battery by peeling off the aluminum laminate film thereof proved that no fluidity of the electrolyte solution was found inside the battery.

### Example 9

A battery was prepared and evaluation thereof was carried out in a manner identical to that in Example 2 except that the aforementioned positive Co electrode was used in place of the positive Mn electrode used in Example 2. The characteristics and the ionic conductivity of the prepared battery are shown in Table 1.

Additionally, inspection of the prepared battery by peeling off the aluminum laminate film thereof proved that no fluidity of the electrolyte solution was found inside the battery.

### Example 10

A battery was prepared and evaluation thereof was carried out in a manner identical to that in Example 3 except that the aforementioned positive Co electrode was used in place of the positive Mn electrode used in Example 3. The characteristics and the ionic conductivity of the prepared battery are shown in Table 1.

Additionally, inspection of the prepared battery by peeling off the aluminum laminate film thereof proved that no fluidity of the electrolyte solution was found inside the battery.

### Example 11

A battery was prepared and evaluation thereof was carried out in a manner identical to that in Example 4 except that the aforementioned positive Co electrode was used in place of the positive Mn electrode used in Example 4. The characteristics and the ionic conductivity of the prepared battery are shown in Table 1.

Additionally, inspection of the prepared battery by peeling off the aluminum laminate film thereof proved that no fluidity of the electrolyte solution was found inside the battery.

### Example 12

A battery was prepared and evaluation thereof was carried out in a manner identical to that in Example 5 except that the aforementioned positive Co electrode was used in place of the positive Mn electrode used in Example 5. The characteristics and the ionic conductivity of the prepared battery are shown in Table 1.

Additionally, inspection of the prepared battery by peeling off the aluminum laminate film thereof proved that no fluidity of the electrolyte solution was found inside the battery.

### Example 13

A battery was prepared and evaluation thereof was carried out in a manner identical to that in Example 6 except that the aforementioned positive Co electrode was used in place of the positive Mn electrode used in Example 6. The characteristics and the ionic conductivity of the prepared battery are shown in Table 1.

Additionally, inspection of the prepared battery by peeling off the aluminum laminate film thereof proved that no fluidity of the electrolyte solution was found inside the battery.

### Example 14

A battery was prepared and evaluation thereof was carried out in a manner identical to that in Example 7 except that the aforementioned positive Co electrode was used in place of the positive Mn electrode used in Example 7. The characteristics and the ionic conductivity of the prepared battery are shown in Table 1.

Additionally, inspection of the prepared battery by peeling off the aluminum laminate film thereof proved that no fluidity of the electrolyte solution was found inside the battery.

### Example 15

A 1:2.5 (molar ratio) mixture (6.6 g) composed of the borate of diethylene glycol monomethacrylate (PE90B) and the borate of triethylene glycol monomethyl ether (MTGB), 87.4 g of a 1:1 (volume ratio) mixed solvent composed of ethylene carbonate and diethyl carbonate, and 6.0 g of LiBF₄ added further were mixed to yield a solution. Further, 0.484 g of Perhexyl PV (manufactured by NOF Corporation) as a polymerization initiator was added to the solution to yield a gel electrolyte precursor solution H. The solution was poured into a 0.5 mm wide space between a pair of stainless steel electrodes and retained at 65° C. for 2 hours in a sealed vessel to yield a gel electrolyte. The ionic conductivity of the gel electrolyte was measured by the aforementioned ionic conductivity measurement method.

Next, the positive Mn electrode and the negative electrode prepared by the aforementioned methods were made to face each other with a separator mediating therebetween; as shown in FIG. 1, stainless steel terminals 5 and 6 were attached to the positive electrode 1 and the negative electrode 2, respectively, and the electrodes were inserted into a pouched aluminum laminate film 4. Further, the gel electrolyte precursor solution H was injected into the separator, and then the pouched aluminum laminate film 4 was sealed and retained at 65° C. for 2 hours to prepare a battery. The characteristics and the ionic conductivity of the prepared battery are shown in Table 1.

Additionally, inspection of the prepared battery by peeling off the aluminum laminate film thereof proved that no fluidity of the electrolyte solution was found inside the battery.

### Comparative Example 1

A 4:1 (ratio by weight) mixture (24 g) composed of tetraethylene glycol monoacrylate (average number of moles of the oxyethylene group added: 4) and trimethylolpropane trimethacrylate, 70 g of a 1:1 (volume ratio) mixed solvent composed of ethylene carbonate and diethyl carbonate, 6 g of LiBF₄ added further, and 0.484 g of Perhexyl PV (manufactured by NOF Corporation) added further as a polymerization initiator were mixed together to yield a gel electrolyte precursor solution I. The solution was poured into a 0.5 mm wide space between a pair of stainless steel electrodes and retained at 65° C. for 2 hours in a sealed vessel to yield a gel electrolyte. The ionic conductivity of the gel electrolyte was measured by the aforementioned ionic conductivity measurement method.

Next, the positive Mn electrode and the negative electrode prepared by the aforementioned methods were made to face each other with a separator mediating therebetween; as shown in FIG. 1, stainless steel terminals 5 and 6 were attached to the positive electrode 1 and the negative electrode 2, respectively, and the electrodes were inserted into a pouched aluminum laminate film 4. Further, the gel electrolyte precursor solution I was injected into the separator, and then the pouched aluminum laminate film 4 was sealed and retained at 65° C. for 2 hours to prepare a battery. The characteristics and the ionic conductivity of the prepared battery are shown in Table 1.

Additionally, inspection of the prepared battery by peeling off the aluminum laminate film thereof proved that no fluidity of the electrolyte solution was found inside the battery.

### Comparative Example 2

A 4:1 (ratio by weight) mixture (24 g) composed of tetraethylene glycol monoacrylate (average number of moles of the oxyethylene group added: 4) and trimethylolpropane trimethacrylate, 70 g of a 1:1 (volume ratio) mixed solvent composed of ethylene carbonate and diethyl carbonate, 6 g of LiN(C₂F₅SO₂)₂ added further, and 0.484 g of Perhexyl PV (manufactured by NOF Corporation) added further as a polymerization initiator were mixed together to yield a gel electrolyte precursor solution J. The solution was poured into a 0.5 mm wide space between a pair of stainless steel electrodes and retained at 65° C. for 2 hours in a sealed vessel to yield a gel electrolyte. The ionic conductivity of the gel electrolyte was measured by the aforementioned ionic conductivity measurement method.

Next, the positive Mn electrode and the negative electrode prepared by the aforementioned methods were made to face each other with a separator mediating therebetween; as shown in FIG. 1, stainless steel terminals 5 and 6 were attached to the positive electrode 1 and the negative electrode 2, respectively, and the electrodes were inserted into a pouched aluminum laminate film 4. Further, the gel electrolyte precursor solution J was injected into the separator, and then the pouched aluminum laminate film 4 was sealed and retained at 65° C. for 2 hours to prepare a battery. The characteristics and the ionic conductivity of the prepared battery are shown in Table 1.

Additionally, inspection of the prepared battery by peeling off the aluminum laminate film thereof proved that no fluidity of the electrolyte solution was found inside the battery.

### Comparative Example 3

A 4:1 (ratio by weight) mixture (4 g) composed of tetraethylene glycol monoacrylate (average number of moles of the oxyethylene group added: 4) and trimethylolpropane trimethacrylate, 90 g of a 1:1 (volume ratio) mixed solvent composed of ethylene carbonate and diethyl carbonate, 6 g of LiN(C₂F₅SO₂)₂ added further, and 0.484 g of Perhexyl PV (manufactured by NOF Corporation) added further as a polymerization initiator were mixed together to yield a gel electrolyte precursor solution K. The solution was poured into a 0.5 mm wide space between a pair of stainless steel electrodes and retained at 65° C. for 2 hours in a sealed vessel to yield a gel electrolyte. The ionic conductivity of the gel electrolyte was measured by the aforementioned ionic conductivity measurement method.

Next, the positive Mn electrode and the negative electrode prepared by the aforementioned methods were made to face each other with a separator mediating therebetween; as shown in FIG. 1, stainless steel terminals 5 and 6 were attached to the positive electrode 1 and the negative electrode 2, respectively, and the electrodes were inserted into a pouched aluminum laminate film 7. Further, the gel electrolyte precursor solution K was injected into the separator, and then the pouched aluminum laminate film 7 was sealed and retained at 65° C. for 2 hours to prepare a battery. The characteristics and the ionic conductivity of the prepared battery are shown in Table 1.

Additionally, inspection of the prepared battery by peeling off the aluminum laminate film thereof proved that no fluidity of the electrolyte solution was found inside the battery.

TABLE 1

| | | II | | | Ionic | | | High-speed |
|---|---|---|---|---|---|---|---|---|
| | I | Nonaqueous solvent | | | conductivity | | | discharge |
| | MTGB/PE90B | content, (wt %) | Electrolyte | Positive electrode | at 25° C. | Initial discharge | DCR | characteristic |
| Example | (molar ratio) | II/(I + II) | salt | active material | (mS/cm) | capacity (mAh) | (Ωcm²) | (%) |
| 1 | 1.0 | 70 | LiBF₄ | Lithium manganese | 4.2 | 1.7 | 65 | 60 |
| | | | | oxide | | | | |
| 2 | 1.5 | 70 | ↑ | ↑ | 4.9 | 1.7 | 50 | 70 |
| 3 | 2.0 | 70 | ↑ | ↑ | 5.1 | 1.7 | 35 | 80 |
| 4 | 2.5 | 70 | ↑ | ↑ | 5.3 | 1.7 | 30 | 85 |
| 5 | 2.5 | 90 | ↑ | ↑ | 6.4 | 1.8 | 10 | 90 |
| 6 | 3.0 | 90 | ↑ | ↑ | 5.9 | 1.8 | 45 | 70 |
| 7 | 2.5 | 90 | LiBETI | ↑ | 6.5 | 1.8 | 8 | 92 |
| 8 | 1.0 | 70 | LiBF₄ | Lithium cobalt | 4.2 | 1.7 | 60 | 65 |
| | | | | oxide | | | | |
| 9 | 1.5 | 70 | ↑ | ↑ | 4.9 | 1.7 | 45 | 75 |
| 10 | 2.0 | 70 | ↑ | ↑ | 5.1 | 1.7 | 27 | 80 |
| 11 | 2.5 | 70 | ↑ | ↑ | 5.3 | 1.7 | 20 | 85 |
| 12 | 2.5 | 90 | ↑ | ↑ | 6.4 | 1.7 | 6 | 93 |
| 13 | 3.0 | 90 | ↑ | ↑ | 5.9 | 1.8 | 30 | 85 |
| 14 | 2.5 | 90 | LiBETI | ↑ | 6.5 | 1.8 | 4 | 95 |
| 15 | 2.5 | 93 | LiBF₄ | Lithium manganese | 7.0 | 1.9 | 1 | 98 |
| | | | | oxide | | | | |
| Comp. Ex. 1 | — | 70 | ↑ | ↑ | 0.6 | 1.6 | 200 | 10 |
| Comp. Ex. 2 | — | 70 | LiBETI | ↑ | 0.7 | 1.6 | 150 | 20 |
| Comp. Ex. 3 | — | 90 | LiBETI | ↑ | 1.4 | 1.6 | 100 | 40 |

MTGB: Borate of triethylene glycol monomethyl ether
PE90E: Borate of diethylene glycol monomethacrylate
Nonaqueous solvent: Mixed solvent of ethylene carbonate and diethyl carbonate in 1:1 volume ratio
LiBETI: LiN(C₂F₅SO₂)₂

### Example 16

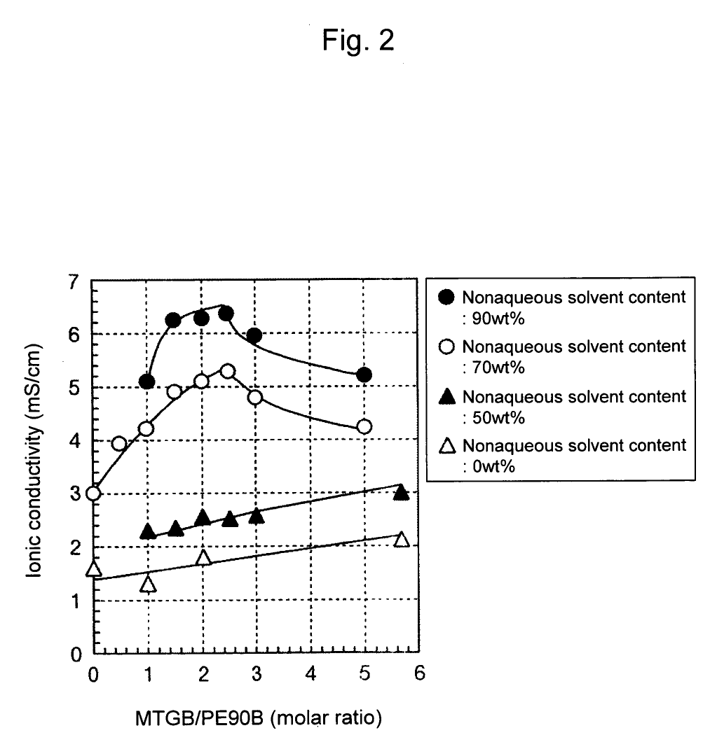

A mixture prepared by mixing, in a predetermined molar ratio, the borate of diethylene glycol monomethacrylate (PE90B) and the borate of triethylene glycol monomethyl ether (MTGB) was mixed with a predetermined weight of a 1:1 (volume ratio) mixed solvent composed of ethylene carbonate and diethyl carbonate, and further added with LiBF₄ so as for the content of LiBF₄ to be 0.64 mole/kg; the mixture was mixed to yield a solution. To 100 g of this mixture, 0.484 g of Perhexyl PV (manufactured by NOF Corporation) as a polymerization initiator was added to yield a gel electrolyte precursor solution. This solution was poured into a 0.5 mm wide space between a pair of stainless steel electrodes and retained at 65° C. for 2 hours in a sealed vessel to yield a gel electrolyte. The ionic conductivity of the gel electrolyte was measured by the aforementioned ionic conductivity measurement method. FIG. 2 shows the ionic conductivities of different gel electrolytes thus obtained.

As can be seen from FIG. 2, the homopolymer of the borate represented by formula (1), or the polymer of the mixture composed of the borates represented by formulas (2) and (3), respectively, to be used in the present invention, exhibits an extremely higher ionic conductivity in the presence of the nonaqueous solvent than in the absence of the solvent. According to FIG. 2, the advantageous effect of the nonaqueous solvent is remarkable for the aforementioned copolymer. Additionally, when the molar ratio of the borate represented by formula (3) to the borate represented by formula (2) is between 1 and 3, the ionic conductivity is higher in the presence of the nonaqueous solvent than in the absence thereof. It has been found that the aforementioned molar ratio is particularly preferably between 2.1 and 3 when the content of the nonaqueous solvent is between 60 and 93% by weight.

### INDUSTRIAL APPLICABILITY

Use of a composition comprising a polymerizable functional group-terminated borate as a polymerizable component makes it possible to easily obtain a gel electrolyte by curing in the presence of a polymerization initiator. In the obtained gel electrolyte, the borate forms a polymer matrix in the concomitant presence of a nonaqueous solvent, so that cations can easily migrate, the ionic conductivity is high, the stability at high temperatures is improved, and furthermore the capability of coping with large current charge/discharge becomes satisfactory.

What is claimed is:

1. A gel electrolyte comprising a polymer matrix, a nonaqueous solvent, and an electrolytic salt, wherein the polymer matrix is obtained by polymerizing a polymerizable functional group-terminated borate represented by formula (1): 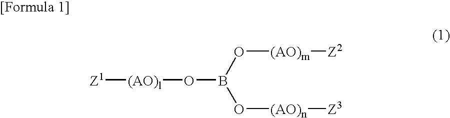
wherein Z¹, Z², and Z³ each independently represent a polymerizable functional group or a hydrocarbon group having 1 to 10 carbon atoms, provided that an average mole of the hydrocarbon group having 1 to 10 carbon atoms is 1.0 to 2.5 per the three groups of Z¹, Z² and Z³; AO represents an oxyalkylene group having 2 to 4 carbon atoms; 1, m, and n are each independently an average number of moles of the oxyalkylene group added of 0 to 100, provided that 1+m+n is 1 to 300; and B represents a boron atom.

2. A gel electrolyte comprising a polymer matrix, a nonaqueous solvent, and an electrolytic salt, wherein the polymer matrix is obtained by polymerizing a mixture composed of a polymerizable functional group-terminated borate represented by formula (2) and a borate represented by formula (3): 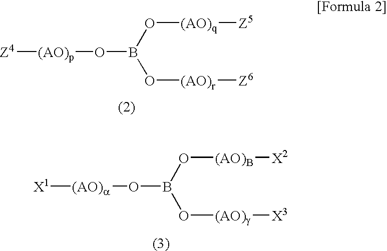
wherein Z⁴, Z⁵, and Z⁶ each independently represent a polymerizable functional group; AO represents an oxyalkylene group having 2 to 4 carbon atoms; p, q, r, α, β, and γ are each independently an average number of moles of the oxyalkylene group added, provided that p+q+r is 1 to 300, and α+β+γ is 1 to 300; X¹, X², and X³ each independently represent a hydrocarbon group having 1 to 10 carbon atoms; and B represents a boron atom.

3. The gel electrolyte according to claim 2, wherein the molar ratio between the compound represented by formula (2) and the compound represented by formula (3) (the number of moles of the compound of formula (3)/the number of moles of the compound of formula (2)) is 1.0 to 3.0.

4. The gel electrolyte according to claim 2, wherein the molar ratio between the compound represented by formula (2) and the compound represented by formula (3) (the number of moles of the compound of formula (3)/the number of moles of the compound of formula (2)) is 2.1 to 3.0.

5. The gel electrolyte according to claim 1, wherein the amount of the nonaqueous solvent is 50 to 95% by weight of the total amount of the electrolyte.

6. The gel electrolyte according to claim 1, wherein the amount of the nonaqueous solvent is 60 to 93% by weight of the total amount of the electrolyte.

7. A secondary battery, wherein said secondary battery comprises a positive electrode comprising a positive electrode active material that deintercalates and intercalates cations, a negative electrode comprising a negative electrode active material that intercalates and deintercalates cations deintercalated from the positive electrode, and an electrolyte layer that lies between the positive electrode and the negative electrode and allows the cations to migrate, and wherein the electrolyte layer is formed of the gel electrolyte according to claim 1.

8. The gel electrolyte according to claim 2, wherein the amount of the nonaqueous solvent is 50 to 95% by weight of the total amount of the electrolyte.

9. The gel electrolyte according to claim 3, wherein the amount of the nonaqueous solvent is 50 to 95% by weight of the total amount of the electrolyte.

10. A secondary battery, wherein said secondary battery comprises a positive electrode comprising a positive electrode active material that deintercalates and intercalates cations, a negative electrode comprising a negative electrode active material that intercalates and deintercalates cations deintercalated from the positive electrode, and an electrolyte layer that lies between the positive electrode and the negative electrode and allows the cations to migrate, and wherein the electrolyte layer is formed of the gel electrolyte according to claim 2.

11. A secondary battery, wherein said secondary battery comprises a positive electrode comprising a positive electrode active material that deintercalates and intercalates cations, a negative electrode comprising a negative electrode active material that intercalates and deintercalates cations deintercalated from the positive electrode, and an electrolyte layer that lies between the positive electrode and the negative electrode and allows the cations to migrate, and wherein the electrolyte layer is formed of the gel electrolyte according to claim 3.

12. A secondary battery, wherein said secondary battery comprises a positive electrode comprising a positive electrode active material that deintercalates and intercalates cations, a negative electrode comprising a negative electrode active material that intercalates and deintercalates cations deintercalated from the positive electrode, and an electrolyte layer that lies between the positive electrode and the negative electrode and allows the cations to migrate, and wherein the electrolyte layer is formed of the gel electrolyte according to claim 5.
